(19) United States
(12) Patent Application Publication
(10) Pub. No.: US 2006/0193272 A1
(43) Pub. Date: Aug. 31, 2006

(54) Method and system for improved handoff of a mobile device between wireless subnetworks

(76) Inventors: Chun-Ting Chou, Ann Arbor, MI (US); Zhun Zhong, Croton on Hudson, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/546,950

(22) PCT Filed: Feb. 23, 2004
(86) PCT No.: PCT/IB04/00469

§ 371 Date: Aug. 25, 2005

Related U.S. Application Data
(60) Provisional application No. 60/451,741, filed on Feb. 27, 2003.
(60) Provisional application No. 60/482,275, filed on Jun. 25, 2003.

(51) Int. Cl. H04B 7/00

(52) U.S. Cl. 370/310

(57) ABSTRACT

Under the present invention, a method and system for improved handoff of a mobile device between wireless subnetworks is provided. Specifically, under the present invention, a mobile device will directly associate with a new access point of a new wireless subnetwork (layer 2 handoff) before associating with a agent of the new subnetwork (layer 3 handoff). Once the association with the new access point is complete, a forwarding request will be sent from the new access point to the old access point of the wireless subnetwork wit which the mobile device w as previously associated. The forwarding request causes all data packets intended for the mobile device that are received by the old access point to be forwarded to the new access point. Then, once the mobile device has the completed its association with the agent of the new wireless subnetwork, the mobile device will receive data packets directly through the new subnetwork.

The present invention generally relates to a method and system for improved handoff of a mobile device between wireless subnetworks. Specifically, the present invention utilizes the I.E.E.E. 802.11(f) protocol to reduce latency and data packet loss for inter-subnetwork handoff of a mobile device.

As wireless networks become more pervasive, the capabilities of mobile devices are increasing. For example, today many mobile devices (e.g., cellular telephones, personal digital assistants, laptop computers, etc.) are capable of connecting to networks through a wireless connection. In general, to connect to a wireless network, a mobile device must associate with certain components therein such as an “access point.” Due to their inherent portability, mobile devices are often “handed-off” from one access point to another. Specifically, as a mobile device user migrates away from an access point with which his/her device is associated, the connection therewith will degrade and eventually fail. To prevent failure of the end-to-end connection, the mobile device must find and associate with any available access point.

As known, a wireless network can have multiple subnetworks. Each subnetwork will generally include, among other components, a mobility agent and a set (e.g., one or more) of access points with which mobile devices can associate. A single subnetwork could represent, for example, all of the “machines” at a single geographic location, in the same building, or on the same local area network (LAN), etc. Having a network divided into subnetworks can provide several advantages. For example, subnetworks allow the network to be connected to the Internet with a single shared network address. Although an organization could get multiple connections to the Internet without subnetworks, it would require an unnecessary use of the limited number of network addresses the Internet has to assign.

Typically, under the Open Systems Interconnection layer model, a wireless subnetwork has several “layers.” Layer 1 is referred to as the physical layer, layer 2 is referred to as the link or medium access control (MAC) layer, layer 3 is referred to as the network layer, and layer 4 is referred to as the transportation layer. Unfortunately, as efficient as subnetworks can be, various issues are raised when a mobile device migrates from one subnetwork to another (known generally as inter-subnetwork migration). Specifically, when a mobile device migrates between subnetworks, the mobile device must be handed off to a new agent (layer 3 handoff), and then to a new access point (layer 2 handoff). Once the mobile device has completed the layer 3 handoff, it is assigned a temporary Internet address (known as a Care-of-Address or COA).

Typically, a layer 3 handoff is managed according to the “Mobil IP” standard. Under the Mobil IP standard, an agent within a subnetwork transmits “agent beacons” approximately every one second. The agent beacons are received by the mobile device as a way of verifying that it is connected to that particular subnetwork. If the mobile device migrates out of the region covered by a first subnetwork, the agent beacons will be missed (e.g., either they will not be received, or they will not be received with sufficient “strength”). In any event, if the mobile device misses three consecutive agent beacons, the Mobil IP standard dictates that it must search for a new subnetwork. Accordingly, the mobile device will attempt to detect a new agent beacon (e.g., from a new subnetwork). When the mobile device detects a new agent beacon, it will associate with an agent and an access point therein. Once associated with the new agent, a new COA will be assigned to mobile device and a message will be sent to the gateway between the subnetworks so that any data packets intended for the mobile device can be transmitted thereto through the new subnetwork (according to the new IP address).

Several problems can arise, however, during the layer 3 hand-off process. Specifically, since the mobile device must wait for three agent beacons to be missed before attempting to associate with an agent, at least three seconds will elapse. This latency not only delays communication to and from the mobile device, but it can also lead to data packet loss. Specifically, before the mobile device has completed the layer 3 handoff, any data packets intended for the mobile device will be transmitted to the old access point. This will not only delay delivery of the data packets to the mobile device, but it will also cause a buildup of data packets buffered at the old access point. Such a buildup could lead to buffer overflow and loss of data packets. Data packets can only be routed to the mobile device through the new subnetwork after the layer 3 handoffs have been completed.

These problems are not generally present when a mobile device performs strictly a layer 2 handoff, such as during migration between access points within a particular subnetwork (known as intra-subnetwork migration). In general, intra-subnetwork migration is handled according to the I.E.E.E. 802.11(f) standard. Under this standard, each access point transmits an “access point” beacon. The access point beacons are transmitted at a far greater frequency (e.g., at 100 milliseconds intervals) than agent beacons are transmitted (e.g., every one second). If a mobile device is associated with a particular access point, the mobile device will continue to receive the access point beacons. As the mobile device migrates away from that access point, the access point beacons will degrade in strength similar to the manner in which an agent beacon would degrade as the mobile device migrates away from the subnetwork. As soon as the strength of the agent beacon falls below some threshold, the mobile device will attempt to detect a new access point beacon from a new access point. However, because the access point beacons are transmitted at a greater frequency, a latency period of several seconds is not present. As such, the communication delays and possible data packet loss observed during inter-subnetwork migration are less of a problem. Accordingly, a layer 2 handoff tends to be both faster and smoother than layer 3 handoff.

In view of the foregoing, there exists a need for a method and system for improved handoff of a mobile device between wireless subnetworks. To this extent, a need exists for a method and system that incorporates the advantages of intra-subnetwork migration into inter-subnetwork communication. To this extent, a further need exists for a method and system that utilizes I.E.E.E. 802.11(f) to buffer and forward data packets during IP layer (i.e., layer 3) handoff of a mobile device.

In general, the present invention provides a method and system for improved handoff of a mobile device between wireless subnetworks. Specifically, under the present invention, as the mobile device migrates from a first wireless subnetwork to a second wireless subnetwork, it will detect the access point beacons being transmitted from the new access point in the second wireless subnetwork. Upon detecting the access point beacons, the mobile device will send an association request thereto. After accepting the association request, the new access point will send a forwarding request to the old access point in the first subnetwork with which the mobile device was associated. The forwarding request causes all data packets intended for the mobile device that are received by the old access point to be forwarded to the new access point. Thus, the mobile device can continue to receive its data packets while the layer 3 handoff is occurring. Once the layer 3 has been completed (after 3 or more seconds), the mobile device can receive and transmit data packets directly through the second subnetwork. Accordingly, by performing a layer 2 handoff while the layer 3 handoff is occurring, and sending the forwarding request, the present invention allows inter-subnetwork handoff to be both smoother and faster.

A first aspect of the present invention provides a method for improved handoff of a mobile device between wireless subnetworks, comprising: providing a mobile device associated with a first access point of a first wireless subnetwork; associating the mobile device with a second access point of a second wireless subnetwork if a power level of an access point beacon transmitted from the first access point falls below a predetermined threshold; and sending a forwarding request from the second access point to the first access point after the association, wherein the forwarding request causes any data packets intended for the mobile device that are received by the first access point to be forwarded to the second access point.

A second aspect of the present invention provides a method for improved handoff of a mobile device between wireless subnetworks, comprising: providing a mobile device associated with a first access point of a first wireless subnetwork; directly associating the mobile device with a second access point of a second wireless subnetwork if a power level of an access point beacon transmitted from the first access point falls below a predetermined threshold; sending a forwarding request from the second access point to the first access point after the association, wherein the forwarding causes requires any data packets intended for the mobile device that are received by the first access point to be forwarded to the second access point; associating the mobile device with an agent of the second wireless subnetwork after the forwarding request has been sent; and receiving additional data packets intended for the mobile device directly through second wireless subnetwork after the association with the agent.

A third aspect of the present invention provides a system for improved handoff of a mobile device between wireless subnetworks, comprising: a first subnetwork having a first access point and a second subnetwork having a second access point, wherein the mobile device is configured to associate with the second access point if a power level of an access point beacon transmitted from the first access point falls below a predetermined threshold; and wherein the second access point is configured to send a forwarding request to the first access point after the association with the mobile device, wherein the forwarding request causes any data packets intended for the mobile device that are received by the first access point to be forwarded to the second access point.

These and other features of this invention will be more readily understood from the following detailed description of the various aspects of the invention taken in conjunction with the accompanying drawings in which:

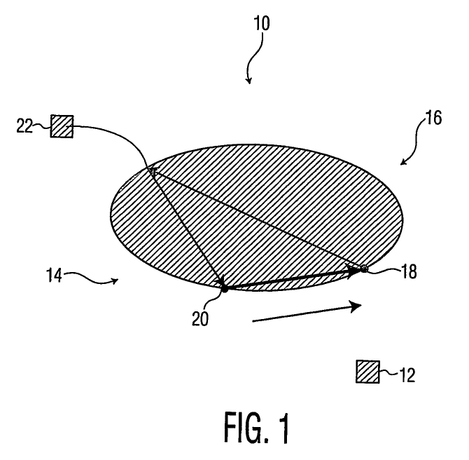

FIG. 1 depicts an overview of Mobil IP, which provides a mechanism for layer 3 handoff of a mobile device between wireless subnetworks.

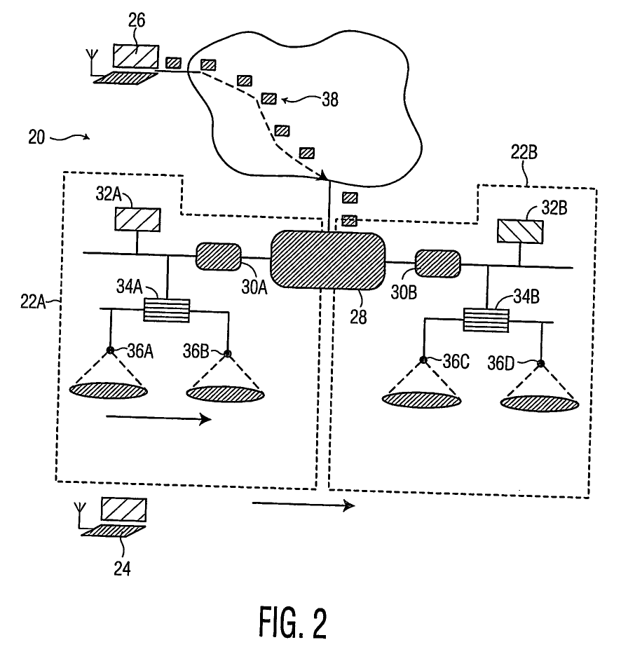

FIG. 2 depicts a diagram of two wireless subnetworks between which a mobile device migrates (i.e., is handed-off) in accordance with the present invention.

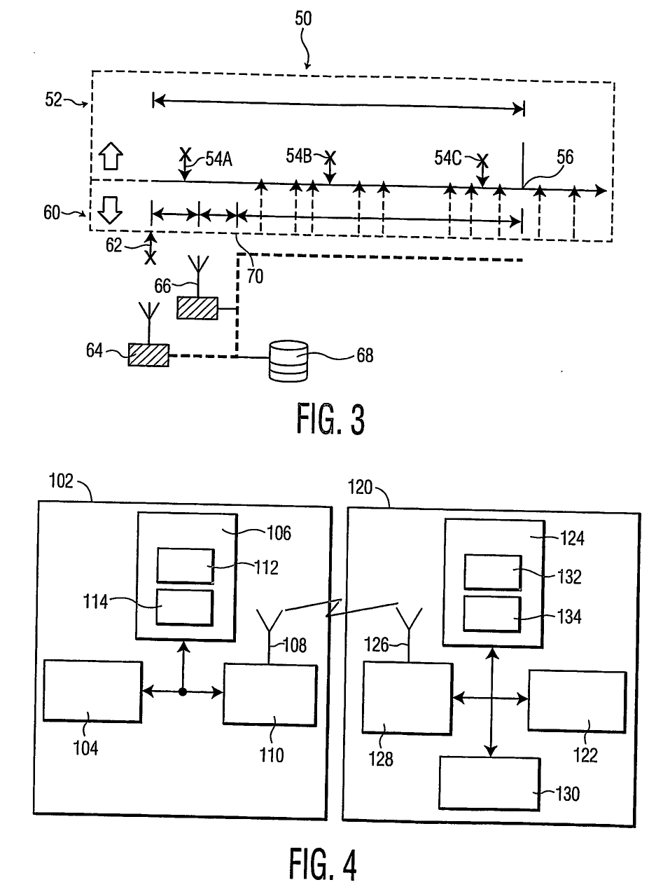

FIG. 3 depicts a timeline comparison of typical layer 3 handoff of a mobile device to the handoff of the mobile device in accordance with the present invention.

FIG. 4 depicts a block diagram of a mobile device and an access point in accordance with the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

Referring now to FIG. 1, an overview 10 of the Mobil IP standard for layer 3 handoff of mobile device/node 12 between a first wireless subnetwork 14 and a second wireless subnetwork 16 is shown. In general, when mobile device 12 migrates from wireless subnetwork 14 to wireless subnetwork 16, it registers with a foreign agent 18 and gets a temporary IP address called Care-of-Address (CoA). Mobile device 12 also updates this information to its home agent 20 in wireless subnetwork network 14 such that home agent 20 can forward data packets from correspondent device/node (CD) 22 to the new CoA. However, as indicated above, the handoff latency observed during this process can be as high as several seconds, which results in serious service degradation, either for real-time application or TCP traffic. Specifically, for layer 3 handoff to occur under Mobile IP, mobile device 12 must miss 3 agent beacons from home agent 20 before it will attempt to associate with foreign agent 18. Since agents such as home agent 20 and foreign agent 18 only transmit one beacon approximately every one second, at least three seconds will elapse before the layer 3 handoff actually occurs.

Once the layer 3 handoff is complete, the new IP address will be assigned to mobile node 12. As known in the art an IP address is a 32-bit sequence that has four groups of decimal numbers. For example, an IP address could appear as follows “130.5.5.25”. Further assume that in this example, the first two groups “130.5” identify the network address, the “.5” identifies the subnetwork address and the “.25” identifies the host address. When a mobile device migrates to a different subnetwork, the subnetwork address of “.5” will change. Accordingly, once a new IP address has been assigned to mobile device 12, all future communications for mobile device 12 can be routed thereto via wireless subnetwork 16.

Referring now to FIG. 2, a diagram 20 of two wireless subnetworks 22A-B between which mobile device 24 migrates (i.e., is handed-off) in accordance with the present invention is shown. As depicted, both wireless subnetworks 22A-B include similar components. Such components include, routers 30A-B, foreign agents 32A-B, MAC bridge 34A-B and access points 36A-D. Gateway 28 resides between wireless subnetworks 22A-B to route data packets received from correspondent node/device 26 to mobile device 24. In general, routers 30A-B and foreign agents 32A-B can be considered layer 3 (IP layer) components, while MAC bridges 34A-B and access points 36A-D can be considered layer 2 (MAC layer) components. In any event, to connect to a particular subnetwork, mobile device 24 will associate with a foreign agent and an access point therein. After the association, any data packets destined for mobile device 24 from correspondent device 26 will be communicated to mobile device 24 through the router, MAC bridge and access point with which the mobile device 24 is associated. It should be understood that diagram 20 is intended to be illustrative only and that other components could be included and/or implementations could be exist. To this extent, it should also be appreciated that the quantity of components (e.g., access points) shown is also illustrative and not intended to be limiting. Still yet, it should be appreciated that foreign agents 32A-B are typically part of, or are connected to, routers 30A-B. They have not been shown as such in FIG. 2 for conceptual purposes only.

Under the present invention, when mobile device 24 migrates from wireless subnetwork 22A to wireless subnetwork 22B, mobile device 24 will directly associate with an access point (e.g., 36C-D) according to I.E.E.E. 802.11(f) while it is attempting to associate with foreign agent 32B under Mobil IP. For example, assume mobile device 24 is initially associated with access point 36B and foreign agent 32A of wireless subnetwork 22A. Further assume that mobile device 24 begins to migrate away from wireless subnetwork 22A to the point where the agent beacons from foreign agent 32A and the access point beacons transmitted from access point 36B begin to lose strength. Under previous embodiments, as indicated above in conjunction with FIG. 1, mobile device 24 would go through the time-consuming process of associating with foreign agent 32B in accordance with the Mobil IP standard (e.g., a layer 3 handoff). That is, three agent beacons from foreign agent 32A must be missed (e.g., be undetected or fall below a predetermined “power” threshold as set forth by the Mobil IP standard) before mobile device 24 can attempt to associate with foreign agent 32B. Since each beacon is transmitted approximately every one second, at least three seconds will elapse before this layer 3 handoff/association is complete.

Under the present invention, mobile device 24 will complete a layer 2 (e.g., MAC layer) handoff to another access point while the layer 3 handoff is occurring. Specifically, as mobile device 24 migrates from wireless network 22A to wireless network 22B, the access point beacons transmitted from access point 36B will be missed (e.g., be undetected or fall below a predetermined “power” threshold as set for by the I.E.E.E. 802.11(f) standard). When this occurs, mobile device 24 will seek access point beacons whose power meets the threshold requirements. To this extent, mobile device 24 will seek to associate with an access point (e.g., access point 36C) in wireless network 22B. Since access point beacons are transmitted at a far greater frequency than the agent beacons, mobile device 24 would attempt to detect and associate with access point 36C in a substantially shorter period of time than it would with foreign agent 32B. For example, in a typical embodiment, mobile device 24 will be able to associate with access point 36C in approximately 300-400 milliseconds (as opposed to more than three seconds to associate with foreign agent 32B).

Once mobile device 24 detects the access point beacons from access point 36C, mobile device 24 will send an association request thereto. As set forth in the I.E.E.E. 802.11(f) standard, the association request includes, among other things, the MAC address of mobile device and the identity of access point 36B. Once access point 36C accepts the association request and sends a confirmation back to mobile device 24, access point 36C will send a forwarding request to the old access point 366B. The forwarding request causes/requires any data packets intended for mobile device 24 that are received by access point 36B to be forwarded to access point 36C. Specifically, during the handoff of mobile device 24 from wireless subnetwork 22A to wireless subnetwork 22B, access point 36B could continue to receive data packets 38 for mobile device 24. Traditionally, data packets 38 were buffered at access point 36B until the layer 3 handoff was complete. However, because the layer 3 handoff could take more than three seconds, the buffer could overflow and data packets could be lost. Under the present invention, the forwarding request is sent to access point 36B as soon as association between mobile device 24 and access point 36C is complete (e.g., 300-400 milliseconds). In a typical embodiment, access point 36C determines the IP address of access point 36B by issuing a Remote Authentication Dial-In User Service (RADIUS) request based on the identity of access point 36B contained in the association request. Specifically, access point 36C will query a database or the like using the identity of access point 36B. The identity is used to cross-reference the database to extract the actual IP address of access point 36B. Once this is determined, the forwarding request is communicated to access point 36B using the extracted IP address.

Upon receiving the forwarding request, access point 36B will forward the buffered data packets to access point 36C (e.g., from access point 36B to MAC bridge 34A to router 30A to gateway 28 to router 30B to MAC bridge 34B to access point 36C). Accordingly, instead of having to wait the three or more seconds before receiving the data packets, mobile node 24 can receive the data packets in a matter of a few hundred milliseconds. The buffering, encapsulating and forwarding of data packets will continue until layer 3 handoff is complete (i.e., mobile device 24 is associated with foreign agent 32B and is assigned a new CoA address (e.g., by router 30B) as explained above). At this point, gateway 28 is instructed to route data packets 38 intended for mobile device 24 through wireless subnetwork 22B instead of through wireless subnetwork 22A.

It should be understood that until mobile device 24 completes the layer 3 handoff and gets a new CoA, it still uses the topologically incorrect IP address. In order to prevent the access point 36C from discarding these forwarded IP packets after decapsulation, access point 36C should associate this “subnetwork-prefix inconsistent” IP address with mobile device's 24 MAC address. Accordingly, once the layer 2 handoff with access point 36C is completed, access point 36C should issue a Reverse Address Resolution Protocol (RARP) request to acquire mobile device 24's old (incorrect) IP address. The RARP request is typically accomplished using mobile device 24's MAC address as identified in the association request. Once the old IP address is obtained, it is associated with the MAC address (and mobile device 24). This is so that whenever access point 36C receives forwarded data packets with the old IP address, the associated MAC address will inform access point 36C to which mobile device the data packets should be sent (i.e., mobile device 24).

In addition, until layer 3 handoff is complete, mobile device 24 will still use the router 30A of the wireless subnetwork 22A as its default router for uplink (e.g., transmission of data packets from mobile device 24). Therefore, the destination MAC address in the MAC-frame header of the outbound data packets will be the MAC address of router 30A. Accordingly, if the access point 36C were to simply send out the data packets without any change, they would not reach router 30A. To address this issue, if access point 36C receives a packet from mobile device 24 with an unknown MAC address, access point 36C will issue a RARP request to identify the IP address of the corresponding component. If no RARP reply is received, the access point 36C marks that MAC address as unreachable in the database. It will then replace the destination MAC address with the MAC address of the router 30B once it receives the data packet from mobile device 24 again. However, if ingress/egress filtering is implemented, access point 36C will encapsulate the data packets and send them back to the wireless subnetwork 20A until the layer 3 handoff is completed.

Referring now to FIG. 3, a timeline comparison 50 of typical layer 3 handoff of a mobile device, to the handoff of the mobile device in accordance with the present invention is shown. Portion 52 of timeline 50 depicts the typical layer 3 handoff, while portion 60 depicts the handoff under the present invention. In viewing portion 50, it can be seen that for layer 3 handoff to be complete, the mobile device must miss three agent beacons 54A-C. Since agent beacons are transmitted from mobility agents only once per second, the complete layer 3 handoff (indicated at point 56) could take at least three seconds. Under the present invention, however, once the link to an access point is down (e.g., either missing access point beacons or the received power strength falls below some predetermined threshold), the mobile device will seek to associate with a new access point 66 (indicated at point 70 along timeline). Once association is complete, new access point 66 will issue a RADIUS request to RADIUS server 68 to obtain the IP address of old access point 64. Once the IP address is determined, a forwarding request is sent to old access point 64. Based on the forwarding request, the old access point will begin forwarding any data packets that it had received for the mobile device. As can be seen in timeline 50, mobile device will begin receiving forwarded data packets at approximately point 70. The forwarding will continue until layer 3 handoff is complete at point 56 after which the mobile device will receive data packets directly through the new mobility agent 32B in FIG. 2. Thus, the time between point 70 and point 56 represents the time during which the mobile device can receive data packets under the present invention that was not previously possible.

It should be understood that the present invention can be realized in hardware, software, or a combination of hardware and software. To this extent, the teachings of the present invention could be implemented through software-based or hardware-based means within the mobile device and/or subnetwork components. Any kind components adapted for carrying out the methods described herein - is suited. A typical combination of hardware and software could be a component with a computer program that, when loaded and executed, carries out the respective methods described herein. Alternatively, a specific use component, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

Referring now to FIG. 4, a block diagram 100 of a mobile device 102 and an access point 120 in accordance with the present invention is shown. It should be understood in advance that block diagram 100 shown in FIG. 4 is intended to be illustrative only, and that mobile device 102 and access point 120 will likely contain additional components not shown. In any event, as depicted, mobile device 102 includes processor 104, memory 106, transmitter/receiver 108 and active packetizer 110. Memory 106 of mobile device 102 can include data 112 and/or program code 114 for carrying out the functions of the present invention described herein. Under the present invention, as mobile device 102 migrates away from a previous access point (not shown) it will begin to detect access point beacons transmitted from access point 120. At that point, program code 1 14 is configured to transmit an association request back to access point 120. Typically, the association request will include data 112 outlined by the I.E.E.E. 802.11(f) standard such as a MAC address of mobile device 102 and an identity of an old access point with which mobile device 102 was associated. The association request will be packetized into one or more data packets by active packetizer 110, and then transmitted via transmitter/receiver 108 to access point 120.

As further shown in FIG. 4, access point 120 includes processor 122, memory 124, transmitter receiver 126, data and program separator 128 and active packetizer 130. The association request will be received via transmitter/receiver 126 and forwarded to data and program separator 128 where the data (e.g., MAC address and old access point identity) will be extracted. A confirmation request/message can be generated using data 132 in memory 124 and then sent as data packets back to mobile device 102 via active packetizer 130. Once the association is complete, program code 134 within memory 124 is configured to issue a RADIUS request to obtain the IP address of the old access point, and then to generate and send a forwarding request thereto. The old access point is configured to receive the forwarding request, and forward any data packets intended for mobile device 102.

Before layer 3 handoff of mobile device is complete, program code 134 within memory 124 is further configured to issue a RARP request to obtain mobile device 102's old IP address (i.e., using the MAC address received in the association request). Then, access point 120 will be able to properly route data packets forwarded from the old access point (with the old IP address) to mobile device 102. Still yet, with respect to data packets received from mobile device 102 before completion of layer 3 handoff, program code 134 is configured to issue a RARP request to obtain an IP address of an old router used by mobile device 102 based on the old router's MAC address identified in the received data packets.

It should be understood that block diagram 100 depicts a software-based implementation of the present invention for illustrative purposes only. Specifically, the underlying functionality of the present invention was shown and described in FIG. 4 as being performed by program code within mobile device 102 and access point 120. However, this need not be the case. Rather, the same functionality could be provided through hardware (or a combination of software and hardware) implemented within mobile device 102 and access point 120.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for improved handoff of a mobile device (24) between wireless subnetworks (22A and 22B), comprising:
providing a mobile device (24) associated with a first access point (36B) of a first wireless subnetwork (22A);
associating the mobile device (24) with a second access point (36C) of a second wireless subnetwork (22B) if a power level of an access point beacon transmitted from the first access point (36B) falls below a predetermined threshold; and
sending a forwarding request from the second access point (36C) to the first access point (366B) after the association, wherein the forwarding request causes any data packets intended for the mobile device (24) that are received by the first access point (36B) to be forwarded to the second access point (36C).

2. The method of claim 1, further comprising forwarding the data packets from the first access point (361) to the second access point (36C) based on the forwarding request.

3. The method of claim 2, wherein the forwarding step comprises:
buffering the data packets at the first access point (36B); and
forwarding the buffered data packets to the second access point (36C).

4. The method of claim 1, wherein the communicating step comprises:
issuing a request from the second access point (36C) to a RADIUS server (68) to determine an IP address of the first access point (36B); and
sending the forwarding request using the determined IP address of the first access point (36B).

5. The method of claim 1, further comprising:
associating the mobile device (24) with an agent of the second wireless subnetwork (22B) after the mobile device (24) is directly associated with the second access point (36C); and
determining a IP address of the mobile device (24) for the second wireless subnetwork (22B) after the mobile device (24) is associated with the agent.

6. The method of claim 1, wherein the directly associating step comprises:
receiving an access point beacon from the second access point (36C) that meets the predetermined threshold; and
sending an association request from the mobile device (24) to the second access point (36C).

7. The method of claim 6, wherein the association request identifies a media access control (MAC) address of the mobile device (24) and an identity of the first access point (36B).

8. The method of claim 7, further comprising:
issuing a reverse address resolution protocol request (RARP) from the second access point (36C) using the MAC address to acquire an IP address of the mobile device (24) for the first wireless subnetwork (22A), after the directly associating step; and
associating the IP address of the mobile device (24) assigned in the first wireless subnetwork (22A) with the MAC address.

9. The method of claim 1, further comprising:
receiving a packet from the mobile device (24) on the second access point (36C), wherein the request includes a MAC address of a component in the first wireless subnetwork (22A); and
issuing a RARP request to determine an IP address of the component using the MAC address in the request.

10. A method for improved handoff of a mobile device (24) between wireless subnetworks (22A and 22B), comprising:
providing a mobile device (24) associated with a first access point (36B) of a first wireless subnetwork (22A);
directly associating the mobile device (24) with a second access point (36C) of a second wireless subnetwork (22B) if a power level of an access point beacon transmitted from the first access point (36B) falls below a predetermined threshold;
sending a forwarding request from the second access point (36C) to the first access point (36B) after the association, wherein the forwarding request causes any data packets intended for the mobile device (24) that are received by the first access point (36B) to be forwarded to the second access point (36C);
associating the mobile device (24) with an agent of the second wireless subnetwork (22B) after the forwarding request has been communicated; and
receiving additional data packets intended for the mobile device (24) directly through second wireless subnetwork (22B) after the association with the agent.

11. The method of claim 10, wherein the forwarding step comprises:
buffering the data packets at the first access point (36B); and
forwarding the buffered data packets to the second access point (36C).

12. The method of claim 10, wherein the communicating step comprises:
issuing a request from the second access point (36C) to a RADIUS server (68) to determine an IP address of the first access point (36B); and
sending the forwarding request using the determined IP address of the first access point (36B).

13. The method of claim 10, wherein the directly associating step comprises:
receiving an access point beacon from the second access point (36C) that meets the predetermined threshold; and
sending an association request from the mobile device (24) to the second access point (36C).

14. The method of claim 13, wherein the association request identifies a media access control (MAC) address of the mobile device (24) and an identity of the first access point (36B).

15. The method of claim 14, further comprising:
issuing a reverse address resolution protocol request (RARP) from the second access point (36C) using the MAC address to acquire an IP address of the mobile device (24) for the first wireless subnetwork (22A), after the directly associating step; and
associating the IP address of the mobile device (24) assigned in the first wireless subnetwork (22A) with the MAC address.

16. A system for improved handoff of a mobile device (24) between wireless subnetworks (22A and 22B), comprising:
a first subnetwork having a first access point (36B) and a second subnetwork having a second access point (36C), wherein the mobile device (24) is configured to associate with the second access point (36C) if a power level of an access point beacon transmitted from the first access point (361) falls below a predetermined threshold; and
wherein the second access point (36C) is configured to send a forwarding request to the first access point (36B) after the association with the mobile device (24), wherein the forwarding request causes any data packets intended for the mobile device (24) that are received by the first access point (36B) to be forwarded to the second access point (36C).

17. The system of claim 16, wherein the mobile device (24) is configured to directly associate with the second access point (36C) before association of the mobile device (24) with an agent of the second wireless subnetwork (22B).

18. The system of claim 17, wherein mobile device (24) is further configured to associate with the agent of the new wireless subnetwork after the mobile device (24) has associated with the second access point (36C), and wherein an IP address of the mobile device (24) for the second wireless subnetwork (22B) is determined after the association with the agent.

19. The system of claim 16, wherein the mobile device (24) is configured to detect the access point beacon and to send an association request to the second access point (36C), wherein the association request includes a MAC address of the mobile device (24) and an identity of the first access point (36B).

20. The system of claim 19, wherein the second access point (36C) is configured to determine an IP address of the first access point (36B) using the identity included in the association request, and to determine an IP address of the mobile device (24) for the first wireless subnetwork (22A) using the MAC address included in the association request.
